(19) United States
(12) Patent Application Publication
(10) Pub. No.: US 2018/0020008 A1
(43) Pub. Date: Jan. 18, 2018

(54) SECURE ASYNCHRONOUS COMMUNICATIONS

(71) Applicant: FUGUE, INC., Frederick, MD (US)

(72) Inventor: Alexander E. SCHOOF, Herndon, VA (US)

(73) Assignee: FUGUE, INC., Frederick, MD (US)

(21) Appl. No.: 15/653,240

(22) Filed: Jul. 18, 2017

Related U.S. Application Data
(60) Provisional application No. 62/363,815, filed on Jul. 18, 2016.

(51) Int. Cl. H04L 29/06; H04L 9/32

(52) U.S. Cl. CPC H04L 63/123; H04L 63/0876; H04L 9/3247; H04L 63/061

(57) ABSTRACT

Techniques for securing and authenticating asynchronous messages using a key manager are provided. A first component sending an asynchronous message to a second component may identify itself to a key manager by a private key and may receive an encrypted signing key from the key manager. The first component may then hash message content, encrypt the hashed message content using the signing key, and send the encrypted result along with the original message content to the receiving component via asynchronous messaging. The receiving component, which may obtain a symmetric signing key from the key manager or from local storage, may decrypt the received encrypted result using the symmetric signing key, and may hash the received original message content using the same hashing algorithm as the sending component; if the two results match, the receiving component may determine that the message is authentic and uncorrupted.

### CROSS-REFERENCE TO RELATED APPLICATION

This application claims the benefit of U.S. Provisional Patent Application No. 62/363,815, filed on Jul. 18, 2016, the contents of which are incorporated herein by reference in their entirety.

### FIELD OF THE INVENTION

This disclosure relates generally to asynchronous network communications and to asynchronous network communications useful in communicating between various components of cloud computing systems.

### BACKGROUND OF THE INVENTION

Cloud computing allows individuals, businesses, and other organizations to implement and run large and complex computing environments without having to invest in the physical hardware (such as a server or local computer) necessary to maintain such environments. Rather than having to keep and maintain physical machines that perform the tasks associated with the desired computing environment, an end-user can instead “outsource” the computing to a computing “cloud” that can implement the desired computing environment in a remote location. The cloud can consist of a network of remote servers hosted on the internet that are shared by numerous end-users to implement each of their desired computing needs. Simplifying the process to build, optimize, and maintain computing environments on the cloud can lead to a positive end-user experience. Allowing a user to develop a robust computing infrastructure on the cloud, while seamlessly optimizing and maintaining it, can minimize frustrations associated with corrupted infrastructure that can occur during the course of operating a computing environment on the cloud.

### SUMMARY OF THE INVENTION

In various network computing systems, asynchronous messaging protocols may be used to send messages between network components. Asynchronous messaging protocols may be particularly useful in cloud computing systems, where asynchronous messaging may be more computationally efficient and/or less expensive than synchronous messaging, and/or in cloud computing systems where a cloud computing service (e.g., cloud service provider) affirmatively requires the use of asynchronous messaging.

In cloud computing environments, inauthentic messages, such as those created by an imposter, may pose serious security risks. In some embodiments, inauthentic messages may enter a cloud computing environment when a malicious actor (e.g., a hacker, a malware program, etc.) sends unauthorized instructions or messages to components of a cloud computing system. In some embodiments, when components of a cloud computing system communicate with one another via asynchronous messaging systems, a malicious actor may have sufficient credentials with a cloud service provider to send messages to a messaging queue of the asynchronous messaging service, as users may use such asynchronous messaging services for legitimate purposes. The malicious actor may abuse his credentials for the asynchronous messaging service by sending messages to a queue of the service that impersonate system components or otherwise deliver unauthorized, harmful, or malicious instructions to system components. For example, inauthentic messages sent to a component of a cloud computing system may be used to compromise data security or to maliciously leverage, alter, or destroy cloud computing environments.

Known techniques for asynchronous messaging in network computing environments and cloud computing environments may provide inadequate security for messages. For example, known techniques may not provide a mechanism to authenticate asynchronous messages that cross trust boundaries or to check those messages for corruption. Accordingly, there is a need for techniques for securing and authenticating messages in asynchronous messaging systems.

In some embodiments, a method for securely sending asynchronous messages comprises: at a first component of a computer network: obtaining a first signing key from a key manager system; using the first signing key to create an authentication code of a message content; and transmitting a message comprising the message content and the authentication code, via an asynchronous messaging system, to a second component of the computer network; and at the second component of the computer network system: receiving, via the asynchronous messaging system, the message comprising the message content and the authentication code; in response to receiving the message: retrieving a second signing key corresponding to the first signing key; and using the second signing key and the authentication code to authenticate the message content.

In some embodiments, a non-transitory computer-readable storage medium stores instructions for securely sending asynchronous messages, the instructions comprising instructions for: at a first component of a computer network: obtaining a first signing key from a key manager system; using the first signing key to create an authentication code of a message content; and transmitting a message comprising the message content and the authentication code, via an asynchronous messaging system, to a second component of the computer network; and at the second component of the computer network system: receiving, via the asynchronous messaging system, the message comprising the message content and the authentication code; in response to receiving the message: retrieving a second signing key corresponding to the first signing key; and using the second signing key and the authentication code to authenticate the message content.

A system for securely sending asynchronous messages comprises two or more components of a computer network and memory storing instructions that, when executed, cause the system to: at a first component of a computer network: obtain a first signing key from a key manager system; use the first signing key to create an authentication code of a message content; and transmit a message comprising the message content and the authentication code, via an asynchronous messaging system, to a second component of the computer network; and at the second component of the computer network system: receive, via the asynchronous messaging system, the message comprising the message content and the authentication code; in response to receiving the message: retrieve a second signing key corresponding to the first signing key; and use the second signing key and the authentication code to authenticate the message content.

### BRIEF DESCRIPTION OF THE DRAWINGS

FIG. 1 illustrates an exemplary cloud computing environment in accordance with some embodiments.

FIG. 2 illustrates an exemplary cloud environment operating system process in accordance with some embodiments.

FIG. 3 illustrates an exemplary cloud environment operating system functional block diagram.

FIG. 4 illustrates a system 400 for securing and authenticating asynchronous messages, in accordance with some embodiments.

FIG. 5A is a sequence diagram depicting secure and authenticated asynchronous messaging between two components, via the use of a key manager, in accordance with some embodiments.

FIG. 5B is a flow chart showing a method for secure and authenticated asynchronous messaging between two components, via the use of a key manager, in accordance with some embodiments.

### DETAILED DESCRIPTION OF THE INVENTION

A cloud computing system (“cloud”) is a large distributed computer system that is shared by multiple clients and is used to virtualize computing environments thereby liberating end-users from the burdens of having to build and maintain physical information technology infrastructure at a local site. These systems also allow users to quickly scale up and down based on their current computing needs.

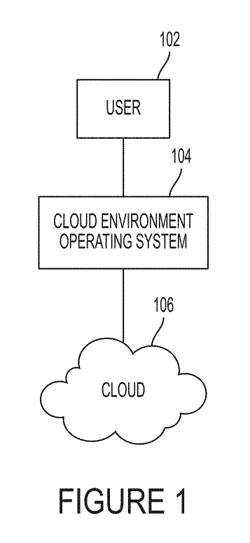

FIG. 1 illustrates an exemplary cloud computing environment according to examples of the disclosure. The cloud computing environment depicted in FIG. 1 comprises user 102, who may wish to implement a computing environment on a cloud 106. Examples of users 100 can include individuals, businesses, or other organizations that wish to utilize the distributed computing system provided by the cloud to implement a computing environment such as a web server, a computer network, a computer database operation, etc.

The cloud 106, as previously discussed, is one or more distributed generalized computers that provide the computing resources to a user to allow them to implement their desired computing environment. Commercial cloud computing services such as AMAZON WEB SERVICES, MICROSOFT AZURE, GOOGLE CLOUD PLATFORM, are examples of distributed computer networks (clouds) available to users (for a fee) and allow them to build and host applications and websites, store and analyze data, among other uses. Clouds are scalable, meaning that the computing resources of the cloud can be increased or decreased based on the real-time needs of a particular user. In one example, a cloud 104 can be utilized to implement a website run by a user 102. The cloud 106 can maintain and operate a web-server based on the specifications defined by the user 102. As web-traffic to the website increases, the cloud can increase the computing resources dedicated to the website to match the surge in traffic. When web traffic is sparse, the cloud 106 can decrease the computing resources dedicated to the website to match the decrease in traffic.

A cloud environment operating system (OS) 104 can help to facilitate the interaction between a user 102 and a cloud computing environment 106. A conventional operating system manages the resources and services of a single computer. In contrast, a cloud environment operating system may manage the resources and services of a cloud environment.

A cloud environment operating system can automate the creation and operation of one or more cloud infrastructures and can create and destroy computing instances on one or more cloud service providers. While the example of FIG. 1 illustrates the infrastructure OS as a stand-alone entity, the example should not be considered limiting. The infrastructure OS can be run on a client device, on a server such as a third party server, or located on a cloud service provider system that runs and executes the computing environment. The infrastructure OS operates separately and interfaces with the cloud computing environment including any command line interfaces or operating systems used by the cloud to build and maintain the computing infrastructure.

An infrastructure OS 104 can interface with a user 102 by allowing the user to specify a desired computing infrastructure in a simplified and concise manner. In one example, a user 102 can specify a computing environment using a programming language designed to interface with the infrastructure OS 104.

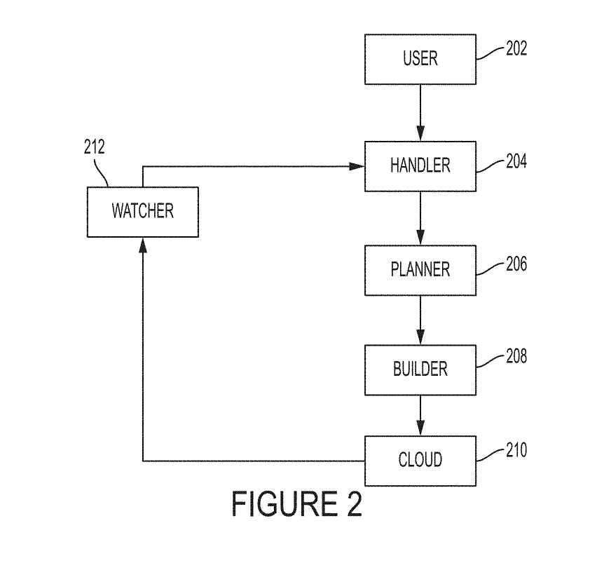

FIG. 2 illustrates an exemplary cloud operating system process according to examples of the disclosure. At step 202, a user can create a composition that describes the computing infrastructure that they want to build in the cloud. In some embodiments, the composition can be written in the form of a declaration which is written in a domain specific programming language. Once the user writes the composition, it can be translated into a hardware-friendly language that is compatible with the cloud operating system that will process the composition to generate the desired infrastructure.

At step 204 the composition generated by the user can be sent to a handler. The handler can capture and version the composition and determine if the composition drafted by the user is a new build (e.g., generating a new computer infrastructure from scratch) or an update to a previously existing infrastructure already running on the cloud. Once the handler receives the composition and makes the determinations described above, it can then trigger the build process by sending the composition to a planning stage.

At step 206, the composition can be passed from the handler stage to planner stage wherein the composition generated by the user is run through a series of modules (described in further detail below) that convert it into a series of instructions to be sent to a builder that will ultimately build the infrastructure in the cloud. The planner stage in addition to interpreting the language of the composition can also perform operations on the composition to determine whether or not there are any errors or structural faults with the composition as written by the user.

At step 208, the planner 206 can transmit the instructions created from the composition to a builder. The builder can take the instructions and build, update, or destroy the infrastructure specified by the user in the specified cloud.

At step 210, the cloud can run the infrastructure specified by the builder in step 208. As the cloud is running the specified infrastructure, should any errors occur in the operation of the infrastructure, the cloud can notify a watcher algorithm at step 212 which can then trigger a rebuild at the handler step 204 of the components of the infrastructure that have generated the error.

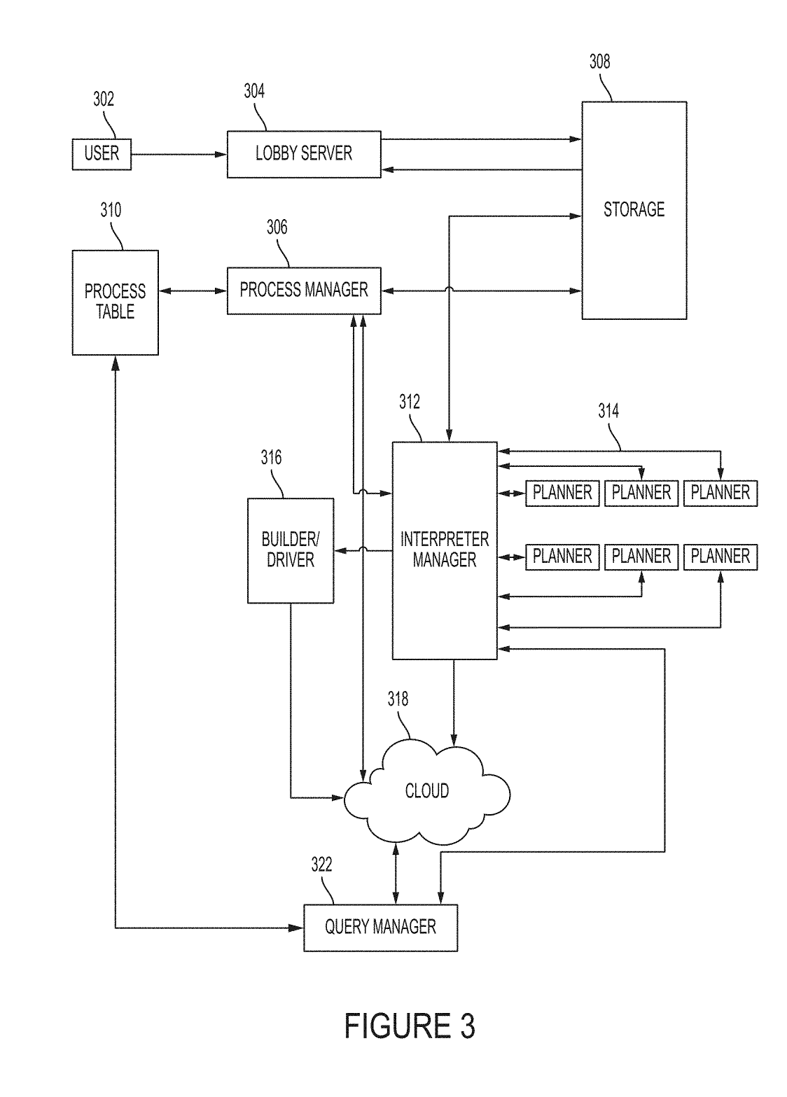

FIG. 3 illustrates an exemplary cloud operating system functional block diagram according to examples of the disclosure. The functional block diagram illustrated in FIG. 3 can, in some examples, implement the process described in FIG. 2.

Block 302 can represent the user process that occurs before operation of the infrastructure OS as described above with respect to FIGS. 1-2. As previously discussed, the user can declare an infrastructure using user-friendly syntax which can then be converted to a lower level language that can be interpreted by the infrastructure OS to build a desired infrastructure on the cloud. User 302 can represent one user, or in some examples can represent multiple users, each of which has specified a desired computing infrastructure to be implemented on a cloud, or multiple clouds.

Block 304 can represent a lobby server. Lobby server 304 can receive low level code (otherwise known as a command line interface) from one or more users and performs a “pitch and catch process” that receives code from one or more users and unpacks it (e.g., distill the parts of the code that will interface with the infrastructure OS) and stores any data that is needed to compile the code and routes the information that comes from the user to the appropriate modules within the infrastructure OS. In addition, the lobby server 304 can identify all of the processes associated with a particular user's command line interface and apply process “tags” to those processes. The process tags can allow the infrastructure OS to track where in the system the processes are currently being executed. This feature can allow for simplicity in scheduling management as will be discussed further below. Lobby server 304 may be communicatively coupled with storage 308.

The lobby server 304 can also handle external data requests. If a request is made to the infrastructure OS for certain forms of data about the run-time environment of the infrastructure OS, the lobby server 304 is able to receive the request, execute it, and send the acquired data to the appropriate stake holder.

Once the code received from the user has been processed by the lobby server 304, the processed code can then be sent to process manager 306. The process manager 306 can manage a process table 310 which lists each and every process to be run by the infrastructure OS. In other words, one set of instructions to build a particular infrastructure by a particular user can be handled as a process. Another set of instructions to build infrastructure by another user can be handled as a separated process. The process manager 306 can manage each separate users tasks as processes within the system by assigning it a process ID and tracking the process ID through the system. Each user's individual tasks to be executed by the infrastructure OS can be managed as separate entities. In this way, the process manager 306 can enable the infrastructure OS to operate as a “multi-tenant” system as opposed to a single-user system. The infrastructure OS can handle requests for infrastructure from multiple users simultaneously rather than being dedicated to a single user or single machine.

In addition to the functions described above, the process manager 306 can also perform status checks on the implementation of the infrastructure in the cloud. In pre-determined time intervals, the process manager 306 can initiate a process whereby a signal is sent to the query manager 322 to determine the status of the infrastructure in the cloud. The query manager 322 can determine the status of the user's infrastructure and send commands to the interpreter manager 312 to take action (described further below) if it is determined from the query manager that the user's infrastructure specification does not match infrastructure present on the cloud.

Once the process manger identifies the process to be executed on the infrastructure OS and stores the processes on process table 310, it can then send those processes to the Interpreter Manager 312 to be converted into a set of instructions that can ultimately be executed by the cloud.

The interpreter manager 312 can be responsible for converting the user's command line interface language (e.g., high level declaration) into a series of specific instructions that can be executed by the infrastructure OS. The interpreter manager 312 can achieve this by employing a series of planning modules 314 that accept, in some examples, resource tables at its input and generates resource tables in which any omissions in the syntax provided by the user are filled in. The interpreter manager 312 can review a resource table sent by the user and send it to the series of planning modules 314 based on what infrastructure needs have been declared by the user. The planning modules 314 alter the user's resource table and return it to the interpreter manager 312. This process may be repeated with other planning modules until the final correct version of the resource table is complete. The interpreter manager 312 then converts the resource table into a machine instruction file which can be referred to as a low level declaration of the computer infrastructure to be built on the cloud. The low level declaration is then sent to the builder/driver 316 (discussed in detail below).

### Secure Asynchronous Messaging System Architecture

Techniques for securing and authenticating asynchronous messages using a key manager are provided. In some embodiments, components communicating via asynchronous messaging protocols may have access to a key manager, which may provide the various components with symmetric signing keys that may be used to authenticate asynchronous messages sent between the components. In some embodiments, some or all elements of a cloud computing system (such as, e.g., system 400 or system 500 as discussed below) may communicate with one another via asynchronous communication. In some embodiments, communications with a key manager may be considered secure and authenticated because the key manager may be a persistent, known, and/or consistent element in a cloud computing environment. On the other hand, various other components of the cloud computing environment may be short-lived, as a large number of components in the cloud computing environment may rapidly come in and out of existence; communication between those components, therefore, may be considered less secure and less inherently verifiable. To address that concern, the techniques disclosed herein may be used to secure and authenticate asynchronous communication between various components in a cloud computing environment in part by leveraging a trusted key manager.

In some embodiments, each unique pair of two communicating components may have a respective unique signing key, and the key manager may securely maintain the respective signing keys in a key store, and it may securely distribute the signing keys to components when they request a signing key needed to send or receive a secure message. For example, a first component sending an asynchronous message to a second component may identify itself to a key manager by a private key, and it may receive an encrypted signing key from the key manager. The first component may then hash message content, and encrypt the hashed message content using the signing key, and send the encrypted result along with the message content to the receiving component via asynchronous messaging. The receiving component, which may obtain a symmetric signing key from the key manager or from local storage such as a local cache, may decrypt the received encrypted result using the symmetric signing key, and it may hash the received message content using the same hashing algorithm as the sending component; if the two results match, the receiving component may determine that the message is authentic and uncorrupted.

In some embodiments, the key manager may provide access to a key store. In some embodiments, the key manager may provide access to a distributed key/value store system, where signing keys are stored as values in the system. The key manager may replace signing keys as needed (e.g., after an expiration period) in the store and/or distributed key/value store system, and it may securely distribute updated signing keys to components upon request. In some embodiments, the key manager and/or communicating components may be part of a cloud environment operating system that manages resources of a cloud environment, and the key store may be governed by the cloud environment operating system. In some embodiments, the key manager and/or the components may be virtual computing components. In some embodiments, the key manager may be instantiated by the cloud environment operating system when a signing key needs to be provided, and it may be shut down or terminated by the cloud environment operating system when it is not in use.

As explained above, inauthentic messages sent over asynchronous messaging protocols may pose serious security risks. In some embodiments, inauthentic messages sent to a component of a cloud computing system may be used to compromise data security or to maliciously leverage, alter, or destroy cloud computing environments. For example, in systems in which a cloud environment operating system has various components that communicate with one another via asynchronous messaging protocols, a malicious party may have access to the same asynchronous messaging service (e.g., AMAZON SQS) used by the cloud environment operating system for operational communications. The malicious party's access to and credentials for the asynchronous messaging service may be otherwise legitimate (e.g., the malicious party may have valid AWS credentials enabling them to use SQS), but the malicious party may seek to hack the cloud environment operating system by using his or her access to the asynchronous messaging service to impersonate one component of the cloud environment operating system sending messages to another component. Such an unauthorized instruction to a component of a cloud environment operating system could contain instructions for the component to carry out any number or harmful or destructive operations, such as publishing sensitive data, overloading system capacity, shutting down security systems, corrupting data, installing malware, destroying cloud environments, sending unauthorized communications, etc.

Thus, there is a need for techniques for securing and authenticating messages in asynchronous messaging systems. In some embodiments, such techniques may be particularly useful in cloud computing environments, as they may allow cloud computing components to verify the authenticity and integrity of messages received. By verifying the authenticity (e.g., the identity of the sender) and integrity (e.g., the message has not been corrupted or manipulated) of a message received by a cloud computing component, the ability of an unauthorized and/or malicious actor to control cloud computing systems with unauthorized instructions may be circumscribed, and security of cloud computing environments may be increased.

It may be assumed, in some embodiments, that processes running inside a cloud environment operating system are within a service trust domain, while command line interfaces running or accessed from an external system and communicating with the cloud environment operating system may be in an unknown trust domain. In some embodiments, multiple, separate trust domains may exist within a single cloud environment operating system. Accordingly, in some embodiments, messages passing between components of a cloud environment operating system may all have the potential to cross one or more trust boundaries. Thus, even if processes within a virtual machine or within a cloud services provider domain are assumed to be secured, techniques for securing and authenticating messages sent within a cloud environment operating system may be important to ensure the security and reliability of cloud based systems.

Accordingly, the techniques discussed herein may provide application-level message integrity checks for components in cloud environment operating systems. These integrity checks may be independent of the underlying cloud services provider, and they may therefore improve security and reliability of cloud based systems.

The techniques disclosed herein may provide message authentication that may be implemented in all application components sending messages across defined trust boundaries, and they may be implemented at the component level. In some embodiments, the techniques disclosed may provide protection, among other things, against replay attacks and against unauthorized users commandeering components of cloud environment operating systems by sending unauthorized messages to their asynchronous messaging queues.

In some embodiments, securing and authenticating messages in asynchronous messaging systems may be achieved through the use of a message authentication code, such as a keyed-hash message authentication code (HMAC). In some embodiments, message authentication codes may create a secure hash by sending message data and a private key to a hashing algorithm, and a receiver may authenticate the message by using the same key and algorithm. In some embodiments, message authentication codes like HMAC may use shared (symmetric) keys and faster algorithms than other encryption solutions.

In some embodiments, the use of shared keys may introduce challenges, particularly in ensuring that each relationship (between a sender and a receiver) is supplied with its own key. In some cloud systems, pre-sharing symmetric keys may not be viable, particularly since some cloud systems do not have a session concept, so key agreement protocols may not apply. Thus, in some embodiments, third-party key management solutions may be useful in efficiently and effectively allowing sending and receiving components in cloud based systems to authenticate messages via shared keys.

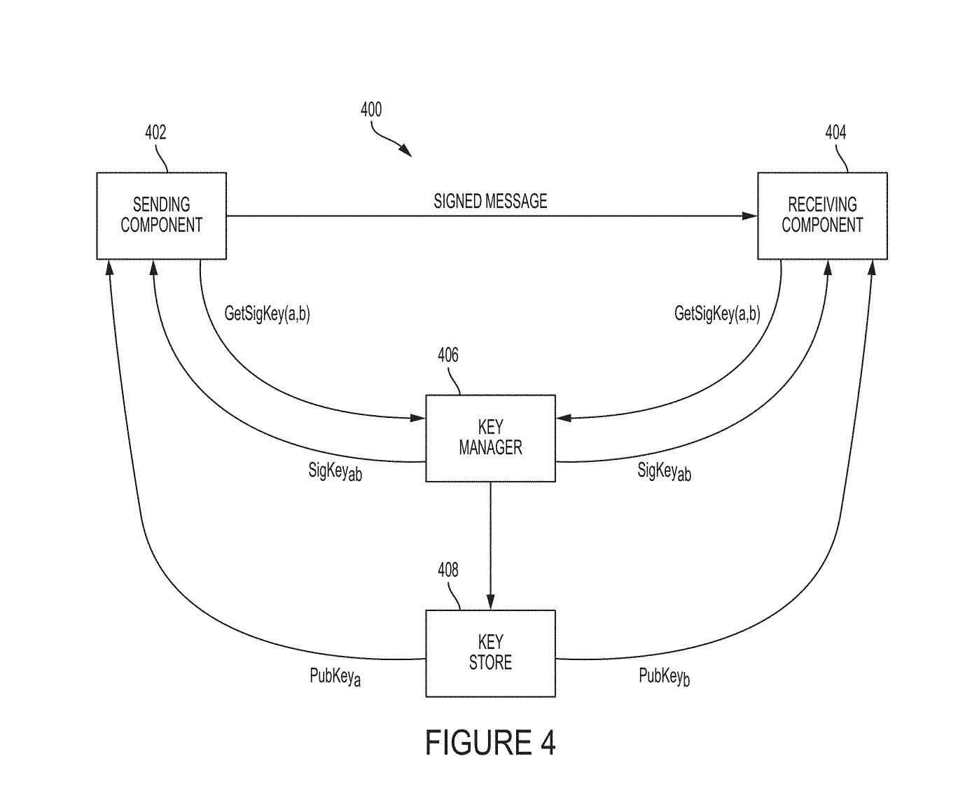

FIG. 4 illustrates a system 400 for securing and authenticating asynchronous messages in accordance with some embodiments. In some embodiments, system 400 may enable efficient, cost-effective, fast, and reliable solutions for using shared keys to send signed messages from one network component to another, including between components of one or more cloud environment operating system. In some embodiments, system 400 may provide a secure service that may be run inside or outside of a boundary of trust of a cloud environment operating system, and it may, in some embodiment, be accessible only to principals who have a security admin role.

In some embodiments, system 400 may enable a key manager to provide symmetric signing keys to network or virtual computing components, such that the components may use the symmetric keys to cryptographically sign the messages that they send to one another, thereby allowing the receiving component to authenticate the received message.

In some embodiments, system 400 comprises sending component 402 and receiving component 404, which may be any network computing components that may communicate with one another via asynchronous messaging. In some embodiments, components 402 and 404 may be virtual computing instances that exist in a cloud computing environment. In some embodiments, components 402 and 404 may be any one or more of the computing components of the cloud environment operating systems shown in FIGS. 1-3 (in some embodiments, components 402 and 404 may be distributed across separate cloud environment operating systems). For example, in one specific embodiment, interpreter manager 312 in FIG. 3 may send messages to builder/driver 316 via asynchronous messaging protocols such as SQS; in some embodiments, authenticating the messages sent to builder/driver 316 may be particularly important to ensure that builder/driver 316 is not hijacked by unauthorized actors and used to execute unauthorized actions on cloud 318.

Returning to FIG. 4, in some embodiments, system 400 comprises key manager 406. In some embodiments, key manager 406 may maintain a registry of principals (which may also be referred to as components), relationships (e.g., pairs of principals or components), and keys. In some embodiments the keys may be Advanced Encryption Standard (AES) keys. In some embodiments, key manager 406 may associate asymmetric key pairs with individual components (also sometimes called principals), and it may associate symmetric signing keys with relationships of two components. Asymmetric key pairs, which may also be referred to as public-private key pairs or simply as key pairs, may include a private key and an associated public key; in some embodiments, the public key may be stored by the key manager and may be identified by a key-ID, which may serve as a label to identify the public key and the component to which is corresponds. In some embodiments, the private key may be maintained on the component to which it corresponds, and it may be sent to other components in encrypted form. In some embodiments, symmetric signing keys (which may also be referred to as signing keys, authentication keys, or symmetric authentication keys) may be identical copies of the same key that may be available to both components in the component relationship to which the signing keys correspond.

For example, key manager 406 may receive requests from sending component 402 and from receiving component 404 to provide a signing key to the respective requesting component. In some embodiments, communication between key manager 406 and components 402 and 404 may be asynchronous communication. In some embodiments, responsive to receiving a request for a signing key from sending component 402 or receiving component 404, key manager 406 may send the requested signing key to the respective component. Note that, in some embodiments, the signing key requested by the components 402 and 404 may be specifically associated with messages sent from sending component 402 to receiving component 404. For example, in FIG. 4, “SigKey_{ab}” may be specifically associated with messages sent from sending component 402 to receiving component 404. In some embodiments, client libraries for various languages may provide functions for accessing key manager 406.

In some embodiments, key manager 406 may be a virtual instance that is not persistently present in a cloud based system. That is to say, in some embodiments, key manager 406 may be instantiated when it is needed, and then may be shut down when it is not needed, and then may be re-instantiated at a future time. In some embodiments, the instantiation of key manager 406 may be handled by a cloud environment operating system of which it may be a part. In some embodiments, more than one key manager may exist at one time, and more than one key manager may therefore be available to the same sending or receiving components. In some embodiments, the number of key managers in a cloud environment operating system may correspond to the number of CPU cores on a machine or to the number of virtual servers being leveraged by a cloud environment operating system; thus, for example, in a quad-core machine, four key managers may simultaneously exist, and in an 8-core machine, eight key managers may simultaneously exist.

In some embodiments, system 400 comprises key store 408. In some embodiments, private keys and signing keys may be wrapped (e.g., encrypted) by key manager 406 and sent to key store 408 for storage, and key manager 406 may also execute get operations against key store 408 to retrieve stored keys. In some embodiments, keys stored in key store 408 may be encrypted with a master password. In some embodiments, signing keys and public keys may be stored in key store 408. In some embodiments, key store 408 may send asymmetric key pairs to associated respective components in a relationship. For example, in FIG. 4, key store 408 may send “PubKeyₐ” to sending component 402 and send “PubKey_{b}” to receiving component 404. Those public keys may then be used at a future time by the respective components to identify the respective components to the key manager and to receive required signing keys in return.

### Key Storage

In some embodiments, key store 408 may be a distributed data store, such as a distributed key/value store system that may store data in a central database and publish/distribute the stored data to one or more of a plurality of instances associated with the system. Examples of distributed key/value store systems are described in U.S. Provisional Patent Application No. 62/363,803, filed Jul. 18, 2016, the disclosure of which is hereby incorporated by reference in its entirety. In some embodiments, each of the plurality of instances may cache or otherwise store the distributed values locally. In some embodiments, distributed key/value store systems may associate stored values with keys that identify the stored values. In the context of a distributed key/value store system, the term “key” may refer to an identifier by which a stored value is called or known to system components. For example, the key “foo” may be set to the value “bar”, such that when a component executed a command to get the value for the key “foo”, “bar” may be returned. In the context of using a distributed key/value store system to store signing keys, the signing key may be the stored value, and the stored value (signing key) may accordingly be identified in the key/value store system by a key or a name. Thus, the signing key “K_{ab}” may be the stored value in a key/value store system, and it may be associated with the key or identifier (e.g., name, label) “sending-receiving”, a string identifying the components to which the signing key corresponds.

In some embodiments of using distributed key/value store systems to store signing keys and public keys for use in secured and authenticated asynchronous communication, a general convention may be used where the key (e.g., name, label) identifying public key values may be the name of the component (e.g., “sending” for sending component 402), and the key (e.g., name, label) identifying signing keys values may be the name of the component relationship (e.g., “sending-receiving” for the relationship between sending component 402 and receiving component 404.)

In some embodiments, key storage for management of keys used to authenticate asynchronous communications may be improved through the use of storage solutions that do not rely on a single virtual machine for storage. Thus, in some embodiments, using cloud services and cloud credentials for critical application security, including for managing keys for authenticating asynchronous communications as discussed herein, may be advantageous. In some embodiments, storing keys in replicated in-memory databases or storing keys in distributed key/value stores may optimally serve high-availability cloud environment operating systems by avoiding storage that relies on a single virtual machine.

### Client Libraries

In some embodiments, system 400 may leverage a client API for messaging in various supported languages. In some embodiments, message metadata standards may already be in place for any cloud environment operating system with which system 400 may interface, and thus minimal changes may be required to define and enable a client API for messaging in system 400. For example, in some embodiments, components of a cloud environment operating system that hand-craft their messages may simply import a messaging library and use simple “send” and “receive” functions to move data. In some embodiments, library modules may transparently handle keys, header data, and authentication. In some embodiments, if message operations are standardized for all components in system 400, then abstractions may be created and used to hide underlying messaging protocols and services (e.g., asynchronous messaging protocols and/or messaging services such as AMAZON SQS or AMAZON SNS).

### Authenticating Public Keys

Various techniques may be used for authenticating public keys. In some embodiments, public key infrastructure (PKI) may be used to authenticate a public key by testing it against a certificate issued by a certificate authority. The certificate authority may itself be verified by a chain or trust that leads to a root certificate authority. In some embodiments, a component may generate a key pair itself and may be responsible for keeping the key pair safe. In some embodiments, receiving components may assume that the public keys of sending components may be trusted without verification from a certificate authority.

In some embodiments, where components of a cloud environment operating system may be installed by the cloud environment operating system itself, key pairs may be generated at the time of installation. Public keys generated by a cloud environment operating system at the time of installation may be registered in a key manager such as key manager 406 at that time. In some embodiments, a key manager such as key manager 406 may enable administrators to update keys at a later point in time. In some embodiments, components may be unable to update their own key pairs, but they may be able to fetch key pairs from the key manager when the component starts up. In some embodiments, this arrangement may avoid the use of public key infrastructure without foreclosing the possibility of its use in the future.

In some embodiments, components of a cloud environment operating system may request a public-private key pair when the system is initialized, which may enable authentication with key manager 406 so that the component can request signing keys for its messaging relationships. Key manager 406 may know the public key of each component in the system and may provide symmetric signing keys to components in accordance with authenticating public key of the requesting component. In some embodiments, generating and publishing public-private key pairs may present a potential vulnerability. In some embodiments, if a distributed key/value store system is used to facilitate communication between key managers and cloud environment operating system components, then access to request a key from the key/value store may present high enough a barrier to entry in order to ensure security.

### Sending Authenticated Asynchronous Messages Using a Key Manager

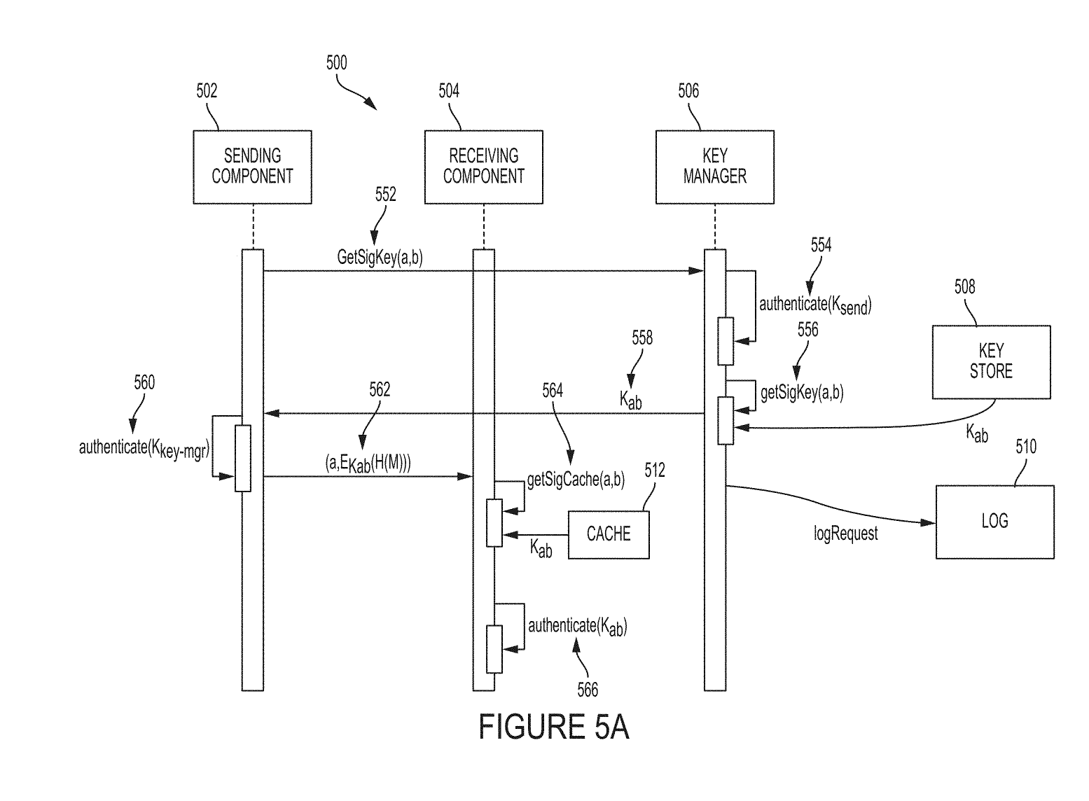

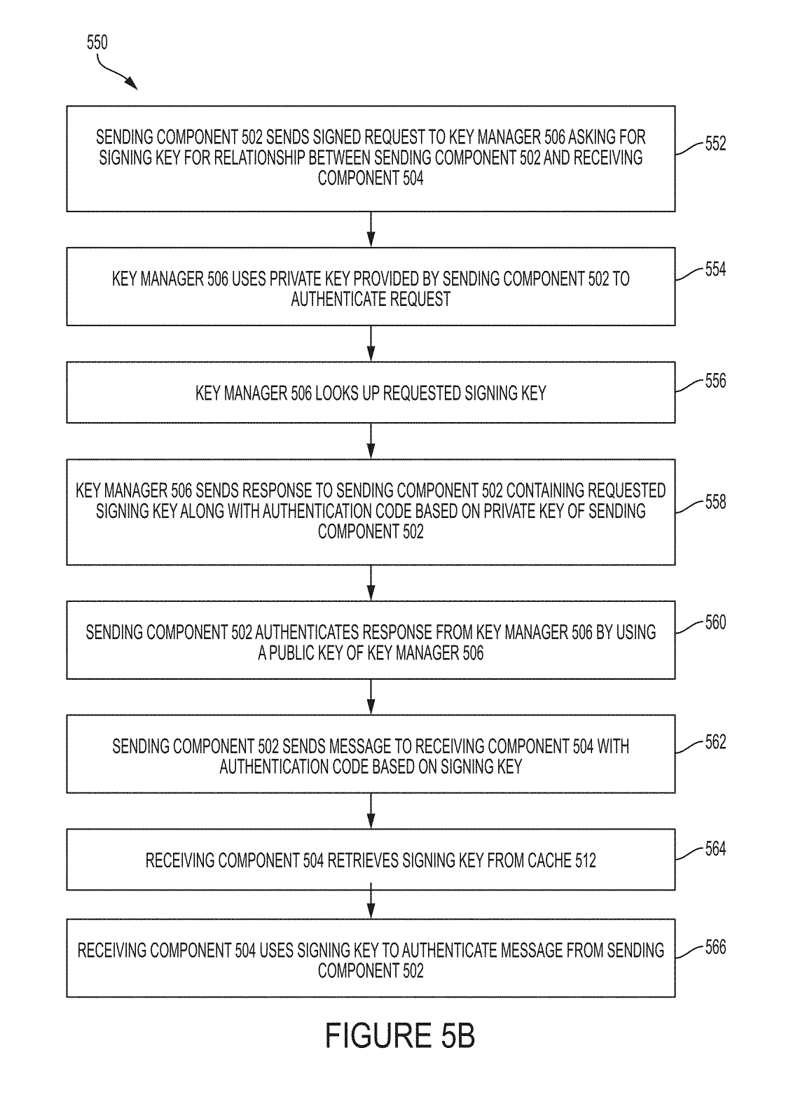

FIG. 5A is a sequence diagram depicting secure and authenticated asynchronous messaging between two components, via the use of a key manager, in accordance with some embodiments. In some embodiments, sending component 502 and receiving component 504 exchange messages with the help of a key manager 506. In some embodiments, sending component 502 may share some or all of the characteristics of sending component 402 in FIG. 4. In some embodiments, receiving component 504 may share some or all of the characteristics of receiving component 404 in FIG. 4. In some embodiments, key manager 506 may share some or all of the characteristics of key manager 406 in FIG. 4. In some embodiments, sending component 502 may be unable to send a message to receiving component 504 until sending component 502 gets the signing key for their relationship. In some embodiments, key manager 506 may operate in a trusted capacity and may have access to key store 508, which may contain component relationships and associated signing keys. In some embodiments, key store 508 may share some or all of the characteristics of key store 408 in FIG. 4. Other components of the system depicted in FIG. 5 will be explained below in conjunction with the explanation of the process depicted by the sequence diagram.

In some embodiments, sending component 502 may be sending its first message (e.g., its first message since process inception) to receiving component 504. In some embodiments (as will be explained in further detail below), sending component 502 may have access to an asymmetric key pair. In some embodiments, receiving component 504 may have been running for some time and may have cached a signing key used in previous communications with sending component 502 (e.g., a key used in previous communications with sending component 502 from a previous instance of sending component 502, where system 500 may recognize that both the previous and current instance of sending component 502 have the same logical component identity).

Thus, in some embodiments, a method 550 for exchanging messages between sending component 502 and receiving component 504 may be as follows. Method 550 is further depicted in the flow chart in FIG. 5B. Thus, the sequence diagram of FIG. 5A and the flow chart of FIG. 5B may be understood as two corresponding visualizations of the same process. It should be noted that, while the steps in method 550 as shown in the flow chart in FIG. 5B make specific reference to the components of sequence diagram 5A (e.g., sending component 502, receiving component 504, etc.), the techniques taught by method 550 may be equally applicable to other systems capable of secure and authenticated asynchronous messaging.

In some embodiments, at step 552, sending component 502 may send a signed request to key manager 506 asking for the signing key for the relationship between sending component 502 and receiving component 504. For example, as shown in FIG. 5A, sending component may send the request “GetSigKey(a,b)” to key manager 506, thereby requesting the signing key “K_{ab}”. In some embodiments, the request may be signed with a private key of sending component 502, which may be denoted “K_{send}”, and may include a public key-ID indicating the identity of the public key to be looked up by the key manager.

In some embodiments, at step 554, key manager 506 may use the private key provided by sending component 502 to authenticate the request. In some embodiments, key manager 506 may have a registry of components and their public keys, and it may look up stored public keys in accordance with received public key-IDs. For example, as shown in FIG. 5A, key manager 506 may execute “authenticate(K_{send})”, thereby using its registry of components and their public keys to access the public key of sending component 502 and use it to authenticate the message. In some embodiments, in the event that the authentication is unsuccessful (e.g., indicates that the message is inauthentic), method 550 may cease. In some embodiments, in the event that the authentication is successful (e.g., indicates that the message is authentic), method 550 may continue.

In some embodiments, other techniques for establishing identity and trust between key manager 506 and a component requesting a key may be used.

In some embodiments, at step 556, key manager 506 may look up the requested signing key. For example, as shown in FIG. 5A, key manager 506 may execute “getSigKey(a,b)”. In some embodiments, looking up the requested signing key may comprise retrieving the requested signing key from a local cache, from other local storage, from a remote database, or from a distributed key value store system, any of which may serve as a key store such as key store 508. In some embodiments, one or more messages may be sent from key manager 506 to key store 508 in order to retrieve the requested signing key. In some embodiments, key manager 506 may act directly on a cache, database, or other storage in order to locate and retrieve a key; in some embodiments, key manager 506 may send a message to another computing component that acts on the behalf of key manager 506 to locate and retrieve a key from a database or other storage.

In some embodiments, looking up the requested signing key may comprise key manager 506 receiving the signing key from key store 508, as shown in FIG. 5A by the arrow from key store 508 to key manager 506, signifying the transfer of the signing key “K_{ab}”.

In some embodiments, key manager 506 may be unable to look up the requested key, because the requested key may not be stored in key store 508. For example, the requested key may have expired and been purged from key store 508, or the relationship for which a key is requested may be a new one. In this case, key manager 506 may, in some embodiments, generate a new key rather than retrieving a pre-existing key. In some embodiments, key manager 506 may create keys by using a random number generator, such as a true random number generator or a cryptographically secure pseudorandom number generator. In some embodiments, key manager 506 may create keys with the use of a hardware random number generator with which it may communicate. In some embodiments, after key manager 506 generates a new key, method 550 may continue in the same or similar manner as it would have continued had the key been retrieved from key store 508.

In some embodiments, key manager 506 may log certain events in log 510, as shown by “logRequest” sent from key manager 506 to log 510 in FIG. 5A. For example, key manager 506 may, in some embodiments, log key requests, successful authentications, authentication failures, signing key retrievals, signing key distributions, other key management operations, or other significant authentication or messaging events. In some embodiments, other components of system 500 may similarly log authentication events and/or messaging events, such as by locally or directly logging events in local or remote databases or caches, or by sending messages to other components such as key manager 506 requesting that an event be logged.

In some embodiments, at step 558, key manager 506 may send a response to sending component 502 containing the requested signing key along with an authentication code based on the private key of key manager 506, which may be denoted “K_{key-mgr}”. For example, as shown in FIG. 5A, key manager 506 may send the signing key “K_{ab}” to sending component 502.

In some embodiments, key manager 506 may send signing key “K_{ab}” to sending component 502 in an encrypted form, rather than as plain text. Thus, in some embodiments, only sending component 502 may be able to decrypt the message containing the key “K_{ab}” from key manager 506, and the security of key “K_{ab}” is increased.

In some embodiments, a key sent from key manager 506 to sending component 502 may have a limited lifetime. For example, data included as a part of “K_{ab}” may indicate that the key will expire after some given amount of time or may indicate a limited time window or validity for the key. In some embodiments, key manager 506 may only maintain a stored copy of a key in key store 508 for some limited period of time relating to the valid lifetime of the key. For example, after the lifetime of a key that key manager 506 distributed to sending component 502 has expired, the key manager may purge and replace that key. Alternately, key manager 506 may retain keys for some amount of time longer than the lifetime of a key that is indicated in the data sent out with the key; for example, key manager 506 may maintain a copy of a distributed key for twice the lifetime that is indicated in the data that was distributed as part of or along with the key. In some embodiments, if a receiving component receives a message and needs to retrieve a copy of the required signing key from key manager 506, the receiving component may only be able to do so if the key has not expired or if the key has not been purged and replaced in key store 508. In some embodiments, if a key has expired when a message is received, then the message authentication may fail, and a new message may be required to be sent with an updated signing key.

In some embodiments, at step 560, sending component 502 authenticates the response from key manager 506 by using the public key of key manager 506. For example, as shown in FIG. 5A, sending component 502 may execute “authenticate(K_{key-mgr})”, thereby using the public key of key manager 506 to authenticate the response. In some embodiments, in the event that the authentication is unsuccessful (e.g., indicates that the response is inauthentic), method 550 may cease. In some embodiments, in the event that the authentication is successful (e.g., indicates that the response is authentic), method 550 may continue.

In some embodiments, at step 562, sending component 502 may send a message to receiving component 504 with an authentication code based on the signing key that was provided by key manager 506. In some embodiments, the message may be sent via asynchronous messaging, in that the message may be sent by sending component 502 to a messaging queue of receiving component 504 queue and may be retrieved from the messaging queue by receiving component 504. For example, as shown in FIG. 5A, sending component 502 may send the message “(a, E_{Kab}(H(M)))” to receiving component 504.

In some embodiments, a message content “M” may be hashed by sending component 502 using a hashing algorithm “H” to generate a hashed message content “H(M)”. (Note that the message content “M” may include header information as well as a message payload.) Sending component 502 may then use the signing key “K_{ab}” to encrypt the hashed message content “H(M)”, generating encrypted output “E_{Kab} (H(M))”. This encrypted output may be the authentication code that is sent from sending component 502 to receiving component 504, along with the original message content “M”, as an asynchronous message. In some embodiments, the message may further include “a”, which indicates the identity of the component sending the message, in this case sending component 502.

In some embodiments, at step 564, receiving component 504 may receive the message from sending component 502 and may retrieve the signing key needed from cache 512. For example, receiving component 504 may read “a” from the message to determine that the message is received from sending component 502 and may execute “getSigKeyCache(a,b)”, which may cause receiving component 504 to retrieve the signing key “K_{ab}” from cache 512. In some embodiments, looking up the requested signing key may comprise retrieving the requested signing key from a local cache, from other local storage, from a remote database, or from a distributed key value store system, any of which may serve as a key store. In some embodiments, one or more messages may be sent from receiving component 504 to cache 512 in order to retrieve the requested signing key. In some embodiments, receiving component 504 may act directly on a cache, database, or other storage in order to locate and retrieve a key; in some other embodiments, receiving component 504 may send a message to another computing component that acts on the behalf of receiving component 504 to locate and retrieve a key from a database or other storage.

In some embodiments, looking up the requested signing key may comprise receiving component 504 receiving the signing key from cache 512, as shown in FIG. 5A by the arrow from cache 512 to receiving component 504, signifying the transfer of the signing key “K_{ab}”. In some embodiments, cached keys may be set to expire after a predefined period of time (e.g., 20 minutes, 1 hour, etc.), after which they may be refreshed by key manager 506 in accordance with the process explained herein. In some embodiments, retrieving keys from cache may reduce computational expense and increase efficiency, because the communicative link between a component and the key manager may be more computationally intensive/expensive, as compared to the asynchronous communicative channel between a sending component and a receiving component. Thus, by avoiding the necessity to query the key manager for a signing key every time a component needs to send a message (or every time a component receives a message), use of a computationally expensive/intensive link with the key manager may be reduced.

In some embodiments, at step 566, receiving component 504 uses the signing key to authenticate the message from sending component 502. For example, as shown in FIG. 5A, receiving component 504 may execute “authenticate(K_{ab})”, thereby using the signing key “K_{ab}^{”} of its relationship with sending component 502 to authenticate the message.

In some embodiments, receiving component 504 may use the signing key “K_{ab}” to decrypt the received authentication code “E_{Kab} (H(M))”, calculating “D_{Kab}(E_{Kab} (H(M)))”, which equals “H(M)”. Receiving component 504 may then use hashing algorithm “H” on the received message content “M” to calculate “H(M)”. Receiving component 504 may then compare the “H(M)” that it calculated from the hashing algorithm “H” with the “H(M)” that it calculated from the decryption “D_{Kab}(E_{Kab}(h(M)))”. If the two values for “H(M)” match, then this may indicate that the message is authentic and has not been tampered with. If the two values do not match, then this may indicate that the message is inauthentic, and the authentication may be deemed unsuccessful.

In some embodiments, in the event that the authentication is unsuccessful (e.g., indicates that the response is inauthentic), the message may be ignored, the failure may be logged, the message may be logged, an alarm may be triggered, the purported sending component may be alerted of the failed message (e.g., so that it may attempt to resend the message in the event of non-malicious failure), a failsafe mode may be activated, or a message may be sent to a system administrator.

In some embodiments, in the event that the authentication is successful (e.g., indicates that the response is authentic), receiving component 504 may take any suitable action based on the content of the authenticated message from sending component 502. For example, receiving component 504 may send a responsive message, forward the message to another component, modify configuration for itself, or execute any action against another computing component based on the content of the authenticated message. For example, in the case where sending component 502 is interpreter manager 312 in FIG. 3, and receiving component 504 is builder/driver 316 in FIG. 3, receiving component 504 may execute actions on cloud 318 in accordance with instructions from sending component 502 as to what actions should be executed on cloud 318.

In some embodiments, additional messages may be sent between sending component 502 and receiving component 504. For example, after receiving and authenticating the message from sending component 502, receiving component 504 may, in some embodiments, send a message in return that may be signed in the same or similar manner as explained above with respect to sending component 502. Upon receiving the return message, sending component 502 may authenticate the message in the same or similar manner as explained above with respect to receiving component 504. In some embodiments, once both a sending and receiving component already have the signing key available in local storage (e.g., in a respective local cache such as cache 512), then secure and authenticated messages may be sent between the components without requiring the use of the key manager. In some embodiments, cached keys may be set to expire after a predefined period of time, after which they may be refreshed by key manager 506 in accordance with the techniques explained above. If a component needs to obtain a new key from a key store in order to send a signed message to a different component, then the component may request the key from the key store and begin the process for sending a new signed message in accordance with the techniques explained above.

In the exemplary method explained above with respect to FIGS. 5A-5B, sending component 502 does not initially have access to a signing key when it needs to send a message to receiving component 504, so sending component 502 first requests a signing key and then sends the message; upon receipt of the message, receiving component 504 already has access to the signing key in its local cache and uses the cached signing key to authenticate the signed message. However, it should be noted that, in some embodiments, a sending component may already have access to the required signing key at the time that it needs to send a message, and it may simply retrieve the needed signing key from a local cache. Similarly, in some embodiments, upon receipt of a signed message, a receiving component may in some embodiments not already have access to the required signing key in its local cache and may therefore have to obtain the needed signing key from a key manager in the same or similar way as explained above with respect to sending component 502 obtaining the needed signing key. Additionally, in some embodiments, it may be the case that neither a sending nor a receiving component has access to a needed signing key when a message is sent and received. In these cases, both the sending component and the receiving component may separately obtain the needed signing key from a key manager in the same or similar way as explained above with respect to sending component 502 obtaining the needed signing key.

### Message Header Content

In some embodiments, secured messages sent between components in accordance with the techniques described above in FIGS. 4 and 5A-C may include a message body and header information, both of which may be passed to a hash function to be hashed before sending. In some embodiments, any cryptographically strong hashing one-way hashing algorithm may be used such that, for one bit of change in input, many bits of change in the output are generated. The hashing algorithm used should, in some embodiments, be cryptographically strong enough that it is infeasible with modern computing hardware to recover the value that was hashed based on the hash output.

In some embodiments, the header information for messages sent to the hash function may be standardized to include a predefined set of string fields, which may be arranged in a predefined order. For example, in some embodiments, the following string fields may, in some embodiments, be standard for message headers for messages sent to the hash function:
timestamp
message ID
message type
sender principal
reply-to (optional)
user principal (optional)
   As shown above, some fields may be optional in some embodiments (such as the “reply-to” field and the “user principal” field shown above). In some embodiments, fields not indicated as optional may be required. In some embodiments, any of the above fields may be required, while, in some embodiments, any of the above fields may be optional, and may thereby optionally be left blank.

In some embodiments, the “timestamp” field may indicate the creation time of the message. In some embodiments, the timestamp field may indicate other time data associated with the message, such as a time at which the message was dispatched. In some embodiments, the value for “timestamp” may be a base-ten integer that may be formatted using a string formatter.

In some embodiments a “message ID” and “message type” fields may be any identification and/or classification information for the message that may be mutually agreed on by the sender and receiver. For example, the “message ID” field may be a unique indicator, such as a numerical indicator, identifying the message and differentiating it from other messages; the “message type” field may be an indicator of a type, category, or class of message that identifies the message as part of a certain group or kind of messages.

In some embodiments, the “sender principal” field may be a name or other identifier of the component from which the message originates. For example, in the process explained above with reference to FIG. 5A, the “sender principal” field may indicate that the message came from sending component 502 by naming sending component 502 (e.g., with the string “sending”).

In some embodiments, the “reply-to” field may indicate the manner in which replies to the message should be sent, such as by indicating an asynchronous messaging queue (e.g., an SQS queue) or a message distribution service topic (e.g., an SNS topic). In some embodiments, the value for the “reply-to” field, or the fact that it has no value, may depend on the underlying transport.

In some embodiments, the “user principal” field may identify the user or user role that initiated the action or actions that resulted in the creation of the message. In some embodiments, not all messages may be associated with a user action or user-role action, but it may be beneficial to track user or user-role information for messages that are associated with a user action or user-role action. In some embodiments, components that receive messages with a value in the “user principal” field may copy the value of the field into the same “user principal” field in the header for messages that they send in response to the message received, such that they value may be passed on, and the information may be retained as to what user or user role initiated the action resulting in the message or series of messages. In some embodiments, using a “user principal” field may thus improve traceability throughout a cloud environment operating system.

It should be noted that, in some embodiments, separate users and user roles may not be considered. In some such embodiments, all command line interface messages may be assumed to have come from a superuser (e.g., a root user or administrator). In some such embodiments, the “user principal” field may not be used or may be left blank.

In some embodiments, other information may be included in the message or in the header. For example, in some embodiments, the message may include a nonce, which may be a random string inserted into the message before hashing in order to create noise/randomness and increase entropy and help protect against replay attacks. In some embodiments, the message may include a context map, which may contain metadata or contextual information that enables receiving components to automatically reject certain kinds of messages and accept certain kinds of messages. In some embodiments, the message may contain a version number or any other useful metadata. In some embodiments, in addition to or in place of information in the header identifying the sending component (e.g., “sender principal”), the message header and/or body may also contain information identifying the receiving component (e.g., a header field such as “receiver principal”, or some information contained in the body of the message itself).

An example of a message header using five required fields and one optional field is shown below. In some embodiments, such a message header may be used for hashed messages sent between various components of a cloud environment operating system, such as the components shown in FIG. 3.

syntax = “proto2”;
package fugueHeader;
message FugueHeader {

required string created = 1;
required string id = 2;
required string type = 3;
required string sender = 4;
required string auth = 5;
optional string replyTo = 6;

}

### Key Manager Access

The examples set forth in this document have focused on situations in which, for the one or more cloud environment operating systems used in conjunction with the secure asynchronous messaging techniques disclosed, there is only one user of the one or more cloud environment operating systems. For example, that user may be a superuser or administrator and may have full privileges. However, in some embodiments, one or more cloud environment operating systems or other network computing environments leveraging the secure asynchronous messaging techniques disclosed herein may have multiple users and/or multiple user roles having different permissions and privileges. For example, in embodiments in which a “user principal” field is used, there may be more than one user and/or more than one user role. In some such embodiments, there may, therefore, be a need for techniques to verify that access to key managers, such as key manager 406 and key manager 506, is legitimate and authorized.

In some embodiments, the entry point to a cloud environment operating system may be a messaging queue of an asynchronous messaging protocol. The cloud environment operating system may poll the queue for input. At the network level, the polling of the queue may comprise an HTTPS request sent to an asynchronous messaging service of a web service provider, and associated credentials may enable full permissions and privileges. Thus, access to those credentials may allow malicious actors full access to the cloud environment operating system, creating a significant risk.

In some embodiments, that risk may be mitigated by carefully defining roles and permissions within the web service provider leveraged by the cloud environment operating system. However, if authorization for access to critical system functions is at the application level, then cloud service provider services and credentials may not apply. The application security function, therefore, may require its own entry point with its own security.

In order to address the need for security for the application security function, in some embodiments, a secure HTTPS listener may be used to authenticate a requesting user and pass the user's requests to a key manager. In some embodiments, this may provide a security channel to a limited set of operations (e.g., high-level command-and-control operations) within a cloud environment operating system. In some embodiments, a command line interface of a cloud environment operating system may use a standard Transport Layer Security (TLS) connection based on application credentials of the cloud environment operating system, in some embodiments, a TLS certificate may need to be managed by the cloud environment operating system. In some embodiments, AWS certificate manager could be used to manage the certificate.

What is claimed is:

1. A method for securely sending asynchronous messages, comprising:
at a first component of a computer network:
obtaining a first signing key from a key manager system;
using the first signing key to create an authentication code of a message content; and
transmitting a message comprising the message content and the authentication code, via an asynchronous messaging system, to a second component of the computer network; and
at the second component of the computer network system:
receiving, via the asynchronous messaging system, the message comprising the message content and the authentication code;
in response to receiving the message:
retrieving a second signing key corresponding to the first signing key; and
using the second signing key and the authentication code to authenticate the message content.

2. The method of claim 1, wherein obtaining the first signing key from the key manager system comprises:
sending a first request to the key manager system, the first request comprising an identification of a relationship between the first component and the second component; and
receiving, from the key manager system, the first signing key in encrypted form.

3. The method of claim 1, wherein retrieving a second signing key corresponding to the first signing key comprises:
determining whether the second signing key corresponding to the first signing key is stored in a local cache of the second component;
in accordance with a determination that the second signing key is stored in the local cache, retrieving the second signing key from the local cache; and
in accordance with a determination that the second signing key is not stored in the local cache:
sending a second request to the key manager system, the second request including an identification of a relationship between the first component and the second component;
and receiving, from the key manager system, the second signing key in encrypted form.

4. The method of claim 1, wherein the key manager system is configured to retrieve the requested first signing key from a key store.

5. The method of claim 1, wherein the key manager comprises an interface for accessing a distributed key/value store system, wherein the values stored in the distributed key/value store system include a plurality of signing keys including the first and second signing key.

6. The method of claim 1, wherein the first component, the second component, and the key manager are virtual computing components included in a cloud environment operating system.

7. The method of claim 6, wherein the key manager is instantiated by the cloud environment operating system when it is determined by the cloud environment operating system that the first component needs to send the message.

8. The method of claim 1, wherein:
the first signing key and the second signing key include a time of expiration; and
the key manager is configured to replace the first and second signing keys at a time corresponding to the time of expiration.

9. The method of claim 8, wherein replacing the first and second signing keys comprises generating a new first signing key and a new second signing key for storage in a key store, such that, when either the first or second instance thereafter requests a signing key for the relationship of the first instance and the second instance, the key manager respectively provides the new first signing key and new second signing key.

10. The method of claim 1, wherein using the first signing key to create an authentication code of the message content comprises:
hashing the message content to generate a first hashed message content; and
using the first signing key to encrypt the first hashed message content to generate an encrypted hashed message content.

11. The method of claim 6, wherein using the second signing key and the authentication code to authenticate the message content comprises:
hashing the received message content to generate a second hashed message content;
using the second signing key to decrypt the encrypted hashed message content to generate decrypted hashed message content; and
comparing the second hashed message content to the decrypted hashed message content to determine whether they are identical.

12. A non-transitory computer-readable storage medium storing instructions for securely sending asynchronous messages, the instructions comprising instructions for:
at a first component of a computer network:
obtaining a first signing key from a key manager system;
using the first signing key to create an authentication code of a message content; and
transmitting a message comprising the message content and the authentication code, via an asynchronous messaging system, to a second component of the computer network; and
at the second component of the computer network system:
receiving, via the asynchronous messaging system, the message comprising the message content and the authentication code;
in response to receiving the message:
retrieving a second signing key corresponding to the first signing key; and
using the second signing key and the authentication code to authenticate the message content.

13. A system for securely sending asynchronous messages, the system comprising two or more components of a computer network and memory storing instructions that, when executed, cause the system to:
at a first component of a computer network:
obtain a first signing key from a key manager system;
use the first signing key to create an authentication code of a message content; and
transmit a message comprising the message content and the authentication code, via an asynchronous messaging system, to a second component of the computer network; and
at the second component of the computer network system:
receive, via the asynchronous messaging system, the message comprising the message content and the authentication code;
in response to receiving the message:
retrieve a second signing key corresponding to the first signing key; and
use the second signing key and the authentication code to authenticate the message content.
